(19) United States
(12) Patent Application Publication
(10) Pub. No.: US 2015/0180119 A1
(43) Pub. Date: Jun. 25, 2015

(54) Functional Beamforming

(71) Applicants: Robert Patrick Dougherty, Bellevue, WA (US); Kevin James Dimond, Seattle, WA (US)

(72) Inventors: Robert Patrick Dougherty, Bellevue, WA (US); Kevin James Dimond, Seattle, WA (US)

(73) Assignee: OptiNav, Bellevue, WA (US)

(21) Appl. No.: 14/137,817

(22) Filed: Dec. 20, 2013

(51) Int. Cl. H01Q 3/00

(52) U.S. Cl. CPC H01Q 3/00

(57) ABSTRACT

Functional beamforming is a vast improvement over classical beamforming methods. Let v be a power greater than unity. The v-th root of the array cross spectral matrix is computed and used in classical beamforming. The v-th power of the resulting beamform map is then computed. This procedure significantly reduced sidelobes, increasing the dynamic range of the results. Assuming the standard model of an incoherent source distribution, it is shown that the computed map values are greater than or equal to the underlying source strengths. Increasing v decreases the map values, steadily reducing sidelobes and peak widths. Quantitative component spectra can be computed by integrating the maps over regions of interest without the errors caused by sidelobes when integrating classical maps. Deconvolution processing is unnecessary. The time and other computer resources required for the computation are virtually identical to classical beamforming.

### CROSS-REFERENCE TO RELATED APPLICATIONS

Not Applicable

### FEDERALLY SPONSORED RESEARCH

Not Applicable

### NAME OF PARTIES TO A JOINT RESEARCH AGREEMENT

Not Applicable

### SEQUENCE LISTING

Not Applicable

### BACKGROUND OF INVENTION

### U.S. Patent Literature

| Patent Number | Issue Date | Patentee |
|---|---|---|
| 8,170,234 | May 2012 | Brooks & Humphreys |
| 7,783,060 | August 2010 | Brooks & Humphreys |
| 5,838,284 | November 1998 | Dougherty |

Johnson, Don H. and Dudgeon, Dan E., “Array Signal Processing” PTR Prentice Hall, 1993
Mocio, James W. and Gramann, Richard A., “Aeroacoustic Measurement in Wind Tunnels Using Adaptive Beamforming Methods” Acoustical Society of America, 1995
Dougherty, R. P., “What is Beamforming?” Berlin Beamforming Conference, 2008
Dougherty, R. P., “Functional Beamforming” to be published at the Berlin Beamforming Conference, 2014
Dougherty, R. P., “Functional Beamforming for Aeroacoustic Source Distributions” to be published at the AIAA Aeroacoustics Conference, 2014

### FIELD OF THE INVENTION

The technical field that this invention relates to is that of beamforming techniques. Particularly, classical beamforming and other variations used with deconvolution techniques that clean up the results and eliminate sidelobes. Data is collected from an array of sensors; most prominent are phased imaging microphones. Other fields of application include underwater acoustics, cellular telephone networks, radio astronomy, seismology, and medical imaging.

### DESCRIPTION OF THE RELATED ART

Beamforming is a powerful and adaptable tool utilizing an arrangement of sensors, for more information see “What is Beamforming?” The geometry of the sensors is particularly important to the results as illustrated by U.S. Pat. No. 5,838,284. Varying shapes will lead to varying interference in the beamform map. With the classical beamforming equation, this interference shows up as artifacts in the results called sidelobes. These sidelobes, especially prevalent at high frequencies, can skew results. On a beamform map they can make it hard to determine where actual sources are. Sidelobes may be almost the same strength as the source itself forcing a dramatic decrease in the dynamic range, the difference between the highest and lowest intensities, which may eliminate weaker sources from view.

Sidelobes being a major issue with beamforming, many deconvolution techniques have been developed and implemented to help eliminate them. These techniques take the results from classical beamforming and try to mathematically separate and eliminate sidelobes from sources, U.S. Pat. Nos. 7,783,060 and 8,170,234 for example. Still, other techniques alter the classical beamforming equation in the same pursuit. Adaptive beamforming as described by “Array Signal Processing” and “Aeroacoustic Measurements in Wind Tunnels Using Adaptive Beamforming Methods” is one such method that uses weighted steering vectors. These methods work with varying degrees of success, but still do not adequately reduce sidelobes. The proposed invention is an improvement in sidelobe reduction greatly attenuating their presence and allowing for much greater dynamic ranges. This in turn reveals much more detail about the beamform maps and allows sources of weaker intensity than the greatest to be more readily viewed.

### BRIEF SUMMARY OF THE INVENTION

The invention does not use deconvolution techniques as it does not post process the results of classical beamforming. Instead, it is a modification to the classical beamforming equation. The invention differs from classical beamforming and other techniques because the cross spectral matrix is raised to a power given as the reciprocal of a certain number greater than one. Classical beamforming is performed using this modified cross spectral matrix, and the entirety of the resulting beamforming map is raised to a power of this number. In this regard, the final results depend nonlinearly upon the elements of the cross spectral matrix. Classical beamforming and related techniques are formulated as linear combinations of the elements of the cross spectral matrix, although sometimes the weights are algebraic functions of the cross spectral matrix. Unless pointed at an actual source, the step of raising the intermediate map to the given power in functional beamforming will reduce the result. This reduces the sidelobes. The form of this equation is different from other techniques and also offers a vast improvement in the dynamic range.

### BRIEF DESCRIPTION OF DRAWINGS

FIG. 1 is a flow chart which illustrates the process of beamforming.

FIG. 2 is a flow chart which illustrates how functional beamforming operates.

### DETAILED DESCRIPTION OF INVENTION

### Symbols

g=an array steering vector. Assumed normalized to unity.
bᵥ(g)=the functional beamforming map value of order v evaluated with steering vector
C=the cross spectral matrix
N=the number of microphones
s=a source strength
ω=angular frequency
′=the Hermitian conjugate
UΣU′=the spectral decomposition of C
σⱼ=the j th eigenvalue of C
Uⱼ=the j th eigenvector of C

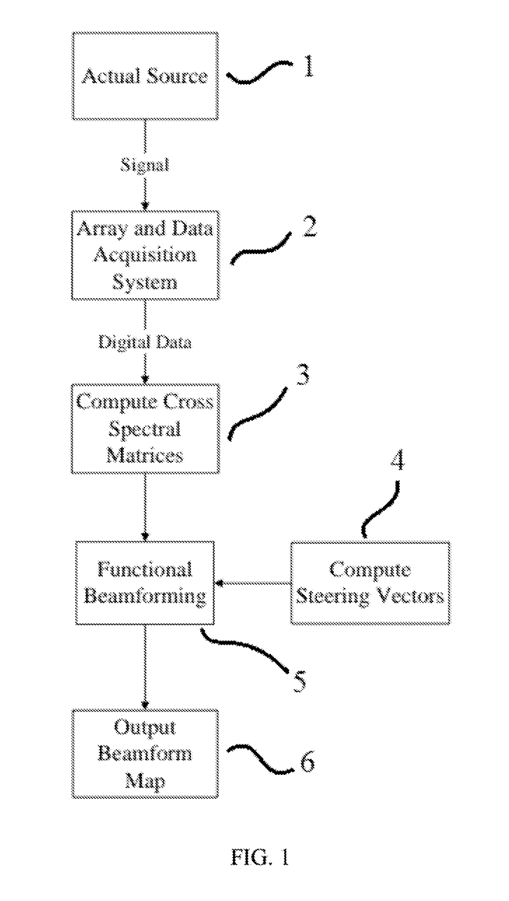

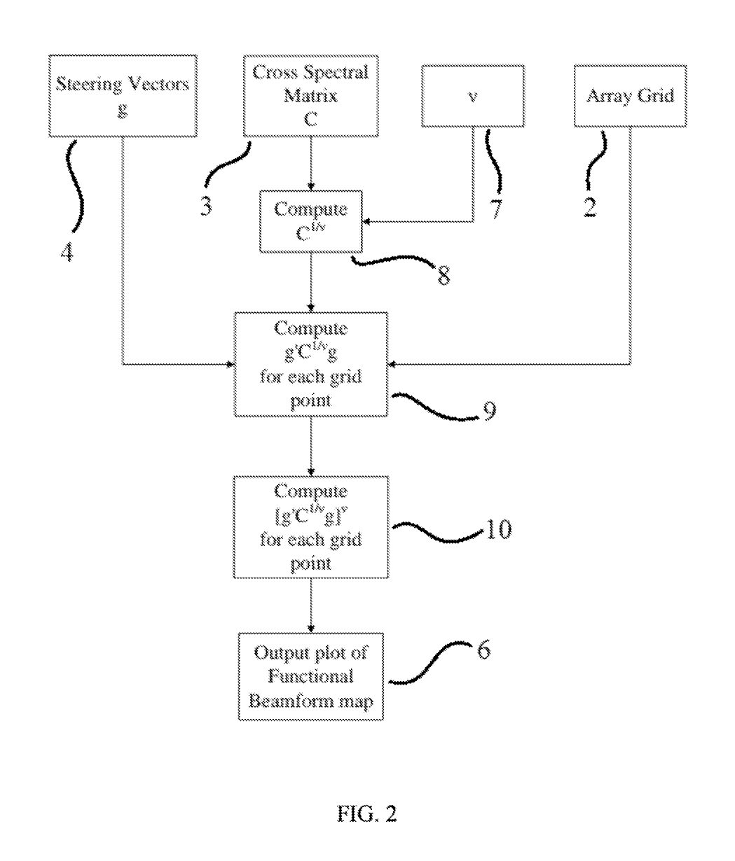

Beamforming in general can be described through the flow chart found in FIG. 1. This shows the general process where a source 1 emits a signal which is then picked up by an array 2. Digital data is then analyzed using the cross spectral matrix 3 and steering vector 4 to compute a beamform map 6. Normally, the classical beamform equation would take the place of the functional beamform 5 block. Using deconvolution techniques, there would be a block between classical beamforming and the beamform map 6 which would clean up the map. FIG. 2 is a more detailed flow chart of the functional beamforming 5 block describing how to carry out the computation.

Let g be the steering vector 4 for a grid point 2 and C be the cross spectral matrix 3. The classical beamform map 6 value for g is

b(g)=g′Cg

Let the spectral decomposition of C be given as

C=UΣU′

and write the principal square root of C as

$${C}^{\frac{1}{2}} = U {Σ}^{\frac{1}{2}} {U}^{′} = U diag ( {σ}_{1}^{\frac{1}{2}} , … , {σ}_{N}^{\frac{1}{2}} ) {U}^{′}$$

This is an example of the spectral mapping theorem from functional analysis. The square root function of the operator C is related to the same function of the eigenvalues. Let a vector beamform map, h, be defined by

$$h = {C}^{\frac{1}{2}} g$$

The scalar beamform map then becomes

b(g)=h′h

A quantity similar to the beamform map can be expressed as

f(g)=g′h

Consider a single source with strength s at a location corresponding to steering vector 4 g₀. Then

C=sg₀g′₀

In this case, the function becomes

$$f ( g ) = {s}^{\frac{1}{2}} {g}^{′} {g}_{0} {g}_{0}^{′} g$$

The expression g′g₀g′₀g=|g′g₀|² is recognized as the standard point spread function (PSF) in beamforming. It reaches unity at g=g₀. At some other points, corresponding to different values of g, is has sidelobes with peak values of perhaps 0.01 (the first Airy ring) or 0.1 (a typical sidelobe of a sparse array design). The function f(g) has a peak of

$${s}^{\frac{1}{2}}$$

at g₀. To obtain a power source estimate, f(g) needs to be squared. This has the result of squaring the sidelobes. If the beamform map 6 has a sidelobe that is 10 dB down from the peak, then f²(g) will have a corresponding sidelobe that is 20 dB down, at least in the single-source case. If there are multiple sources at locations whose steering vectors 4 are mutually orthogonal, then this result still holds exactly: the dynamic range of f²(g), in dB, is twice as large as the dynamic range of FDBF. If there are multiple sources that are not mutually orthogonal, then experiments show that the result still approximately holds.

The improved beamforming expression can be written

$${f}^{2} ( g ) = {[ {g}^{′} {C}^{\frac{1}{2}} g ]}^{2}$$

Generalizing the square root function to the power 1/v gives the functional beamforming expression of power v 7

$${b}_{v} ( g ) = {[ {g}^{′} {C}^{\frac{1}{v}} g ]}^{v}$$

The mathematics of which are explained by FIG. 2. After computing the cross spectral matrix 3 and choosing v 7, compute

$${C}^{\frac{1}{v}}$$

8, then

$${g}^{′} {C}^{\frac{1}{v}} g 9 ,$$

and lastly

$${[ {g}^{′} {C}^{\frac{1}{v}} g ]}^{v}$$

10. Be careful to use the proper array grid point 2 geometry and corresponding steering vector 4.

For single sources, the dynamic range is ideally increased by the power of power v 7 relative to FDBF. It will be shown that if there is a distribution of a potentially infinite number of incoherent sources (with steering vectors 4 that do not have to be orthogonal), such that

$$C = {\sum }_{i = 1}^{∞} {s}_{i} {g}_{i} {g}_{i}^{′}$$

then the functional beamforming map 6 is always greater than or equal to the actual source strength at each point:

bᵥ(gᵢ)≧sᵢ

Using the spectral decomposition of C, the functional beamform map 6 can be expressed as

$${b}_{v} ( g ) = {[ {\sum }_{j = 1}^{N} {a}_{j} {σ}_{j}^{\frac{1}{v}} ]}^{v}$$

where

aⱼ=|g′Uⱼ|²

This is a weighted power mean of the eigenvalues. It can be shown that, if v₂>v₁ then bᵥ_{₂}(g)≦bᵥ_{₁}(g). In view of the inequality bᵥ(gᵢ)≧sᵢ, this means that increasing v 7 does not make the functional beamforming 5 expression worse as an estimate of the source strength. It usually makes it better by further reducing the sidelobes as higher powers of the PSF are taken.

The limiting result is known:

$${lim}_{v -> ∞} {b}_{v} ( g ) = {\prod }_{j = 1}^{N} {σ}_{j}^{{a}_{i}}$$

This expression requires modification to be robust in the case of zero eigenvalues. In practice, it may be better to use equation

$${b}_{v} ( g ) = {[ {g}^{′} {C}^{\frac{1}{v}} g ]}^{v}$$

with a large but finite value of v 7. It could be consistent with bᵥ(gᵢ)≧sᵢ for the functional beamforming 5 result for source point to be below the strength of a source at that point if the steering vector 4 is not accurately computed. As always in beamforming, there are many types of errors that can lead to inaccurate steering vectors 4, including an incorrect physical model of the source. More information on functional beamforming can be found in “Functional Beamforming” and “Functional Beamforming for Aeroacoustic Source Distributions”.

1. A mathematical formula for beamforming computations given by
$${b}_{v} ( g ) = {[ {g}^{′} {C}^{\frac{1}{v}} g ]}^{v}$$
where C is the array cross spectral matrix, g is a steering vector, and v is a number greater than unity.
